(19) United States
(12) Patent Application Publication
(10) Pub. No.: US 2024/0339857 A1
(43) Pub. Date: Oct. 10, 2024

(54) POWER MANAGEMENT UNIT BATTERY BOOST CONVERTER

(71) Applicant: Raytheon Company, Waltham, MA (US)

(72) Inventors: Stephen John Fedigan, Marana, AZ (US); Mahitha Velagapudi, Allen, TX (US); Dale E. Brech, Tucson, AZ (US)

(21) Appl. No.: 18/131,180

(22) Filed: Apr. 5, 2023

(51) Int. Cl. H02J 7/34; H02J 7/00

(52) U.S. Cl. CPC H02J 7/342; H02J 7/0047; H02J 7/00712; H02J 2207/20

(57) ABSTRACT

A battery staging system including a first and second battery in operative communication with each other and an electrical load; a boost controller in operative communication with the first and second battery; an inductor in operative communication with the boost controller, the first battery, a ground and the second battery; the inductor connected between first battery and ground for a predetermined time to obtain an inductor current; the boost controller is configured to pull a first battery current and drive it into the second battery responsive to the predetermined inductor current; the inductor being connected to the second battery responsive to the inductor obtaining the predetermined inductor current; the inductor is reconnected between the first battery and the ground before the inductor current reaches zero; and the boost controller configured to pull the first battery current from the first battery until the first battery voltage reaches a target voltage.

### BACKGROUND

The present disclosure is directed to a power management unit battery boost converter that enables sequential firing of thermal batteries.

Certain critical power applications require an electrical power source capable of ultrahigh reliability and ultralow maintenance and virtually unlimited shelf life. In such batteries, the electrodes are fully assembled for operation, but the electrolyte is held in reserve in a separate container which may be within the battery container. Since there is no consumption of the electrodes under these circumstances, the shelf life of the battery is essentially indefinite. However, once the electrolyte is released from its reserve container, such as by mechanical puncture, explosive squib rupture or by any other means as are well known in the art, the battery is activated and thereafter has a limited standby life. Thermal batteries are useful for applications requiring extended storage time because they avoid deterioration of the active materials during storage and eliminate the loss of capacity due to self-discharge. A key feature is that the electrolyte is frozen at room temperature and is melted by the activation of heat pellets. Thermal batteries can have multiple chemistries. For example, a eutectic mixture of inorganic salts with inorganic binder can serve as the electrolyte between the anode and the cathode. A conductive heat source, consisting of iron and potassium perchlorate, is placed between each cell. When initiated, the heat pellets ignite, releasing heat and melting the eutectic electrolyte, producing voltage and current.

A thermal battery is totally inert and non-reactive until activated. Because most external environments have little or no effect on the inactivated battery, it can be stored for 20+years. The battery can be activated at any time without preparation and will begin supplying power almost immediately. After activation, the battery quickly reaches peak voltage, which declines gradually during the rest of its active life as it cools to room temperature. Once activated, the battery functions until a critical active material is exhausted or until the battery cools below the electrolyte's melting point.

Initiating thermal batteries simultaneously constrains a mission for a limited duration of time to provide the necessary electrical power to the electrical loads. There are certain conditions and/or missions that require a longer period of battery power available.

Thermal batteries can be utilized in groups such that a first battery can be activated and at a future point in time, a subsequent battery can be activated to take on the load. However, the first battery being taken offline is susceptible to thermal runaway conditions if the power being produced is not properly managed. The offline battery can go into a thermal runaway condition and have venting problems unless a minimum current is drawn from the offline battery to a point in time when the voltage drops below a value of 10% of full voltage.

What is needed is a controller that allows for sequential firing of thermal batteries extending available battery power as well as allowing for offline battery management without the unwanted heat loads in the battery staging electronics package.

### SUMMARY

In accordance with the present disclosure, there is provided a battery staging system comprising a first battery in operative communication with an electrical load; a second battery in operative communication with the electrical load and in operative communication with the first battery; a boost controller in operative communication with the first battery and the second battery; an inductor in operative communication with the boost controller, the first battery, a ground and the second battery; whereby the inductor is connected between the first battery and the ground for a predetermined time to obtain a predetermined inductor current; the boost controller is configured to pull a first battery current from the first battery and drive the first battery current into the second battery responsive to the predetermined inductor current; the inductor being connected to the second battery responsive to the inductor obtaining the predetermined inductor current; whereby the inductor is reconnected between the first battery and the ground before the inductor current reaches zero; and the boost converter controller configured to pull the first battery current from the first battery until the first battery voltage reaches a target voltage.

A further embodiment of any of the foregoing embodiments may additionally and/or alternatively include the first battery is a thermal battery and the second battery is a thermal battery.

A further embodiment of any of the foregoing embodiments may additionally and/or alternatively include the first battery is activated and connected to the electrical load before the second battery is activated and connected to the electrical load.

A further embodiment of any of the foregoing embodiments may additionally and/or alternatively include the boost controller includes an inner loop, the inner loop being configured to control the first battery current.

A further embodiment of any of the foregoing embodiments may additionally and/or alternatively include the inner loop is configured to measure a loop error and apply one of a full voltage or no voltage for a predetermined period of time.

A further embodiment of any of the foregoing embodiments may additionally and/or alternatively include the boost controller includes an outer loop; the outer loop being configured to control the first battery voltage.

A further embodiment of any of the foregoing embodiments may additionally and/or alternatively include the boost controller is configured to transfer a charge from the first battery to the second battery, wherein the first battery is offline and the second battery is online.

A further embodiment of any of the foregoing embodiments may additionally and/or alternatively include the boost controller is configured to measure battery impedance.

A further embodiment of any of the foregoing embodiments may additionally and/or alternatively include the boost controller is configured to determine an online battery resistance responsive to: a measurement of the online battery voltage when the inductor is connected to the online battery; and a measurement of the online battery voltage when the inductor is disconnected from the online battery.

In accordance with the present disclosure, there is provided a process for transferring charge from an offline battery to an online battery utilizing a boost controller comprising operatively connecting a first battery with an electrical load; subsequently operatively connecting a second battery with the electrical load and operatively connecting the second battery in communication with the first battery; operatively connecting a boost controller in operative communication with the first battery and the second battery; operatively connecting an inductor in communication with the boost controller, the first battery, a ground and the second battery; whereby the inductor is connected between the first battery and the ground for a predetermined time to obtain a predetermined inductor current; configuring the boost controller to pull a first battery current from the first battery and drive the first battery current into the second battery responsive to the predetermined inductor current; connecting the inductor to the second battery responsive to the inductor obtaining the predetermined inductor current; whereby the inductor is reconnected between the first battery and the ground before the inductor current reaches zero; and configuring the boost controller to pull the first battery current from the first battery until the first battery voltage reaches a target voltage.

A further embodiment of any of the foregoing embodiments may additionally and/or alternatively include the first battery is a thermal battery and the second battery is a thermal battery.

A further embodiment of any of the foregoing embodiments may additionally and/or alternatively include the process further comprising activating and connecting the first battery to the electrical load before activating and connecting the second battery to the electrical load.

A further embodiment of any of the foregoing embodiments may additionally and/or alternatively include the process further comprising wherein the boost controller includes an inner loop; and controlling the first battery current with the inner loop.

A further embodiment of any of the foregoing embodiments may additionally and/or alternatively include the process further comprising wherein the boost controller includes an inner loop; and controlling the first battery current with the inner loop.

A further embodiment of any of the foregoing embodiments may additionally and/or alternatively include the process further comprising configuring the inner loop to measure a loop error and apply one of a full voltage or no voltage for a predetermined period of time.

A further embodiment of any of the foregoing embodiments may additionally and/or alternatively include the process further comprising wherein the boost controller includes an outer loop; and controlling the first battery voltage with the outer loop.

A further embodiment of any of the foregoing embodiments may additionally and/or alternatively include the process further comprising configuring the boost controller to transfer a charge from the first battery to the second battery responsive to the first battery being offline and the second battery being online.

A further embodiment of any of the foregoing embodiments may additionally and/or alternatively include the process further comprising configuring the boost controller to measure battery impedance.

A further embodiment of any of the foregoing embodiments may additionally and/or alternatively include the process further comprising configuring the boost controller to determine an online battery resistance responsive to: a measurement of the online battery voltage when the inductor is connected to the online battery; and a measurement of the online battery voltage when the inductor is disconnected from the online battery.

A further embodiment of any of the foregoing embodiments may additionally and/or alternatively include the process further comprising controlling a first power switch with the boost controller; and controlling a second power switch with the boost controller.

In accordance with the present disclosure, there is provided a battery staging system comprising a first battery in operative communication with an electrical load; a second battery in operative communication with the electrical load and in operative communication with the first battery; a first boost controller in operative communication with the first battery and in operative communication with the second battery; a first inductor in operative communication with the first boost controller, the first battery, a ground and the second battery; whereby the first inductor is connected between the first battery and the ground for a predetermined time to obtain a first predetermined inductor current; the first boost controller is configured to pull a first battery current from the first battery and drive the first battery current into the second battery responsive to the first predetermined inductor current; the first inductor being connected to the second battery responsive to the first inductor obtaining the predetermined inductor current; whereby the first inductor is reconnected between the first battery and the ground before the first inductor current falls below zero; and the first boost controller configured to pull the first battery current from the first battery until the first battery voltage reaches a target voltage; a second boost controller in operative communication with the second battery and in operative communication with an nth battery; a second inductor in operative communication with the second boost controller, the second battery, a ground and the nth battery; whereby the second inductor is connected between the second battery and the ground for a predetermined time to obtain a second predetermined inductor current; the second boost controller is configured to pull a second battery current from the second battery and drive the second battery current into an nth battery responsive to the second predetermined inductor current; the second inductor being connected to the nth battery responsive to the second inductor obtaining the second predetermined inductor current; whereby the second inductor is reconnected between the second battery and the ground before the second inductor current falls below zero; and the second boost controller configured to pull the second battery current from the second battery until the second battery voltage reaches a target voltage.

Other details of the battery staging system are set forth in the following detailed description and the accompanying drawings wherein like reference numerals depict like elements.

### BRIEF DESCRIPTION OF THE DRAWINGS

FIG. 1 is a schematic representation of an exemplary battery staging system with a boost converter topology.

FIG. 2 is a schematic representation of an exemplary battery staging system with a boost converter topology.

FIG. 3 is a schematic representation of an exemplary battery staging system with a boost converter topology.

### DETAILED DESCRIPTION

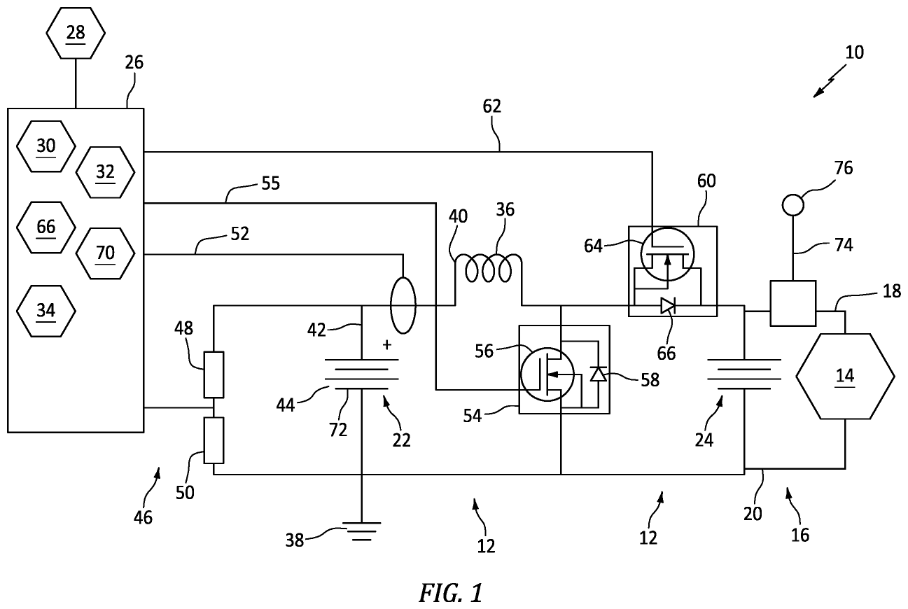

Referring now to FIG. 1, a battery staging system 10 is shown. A grouping of batteries 12 can be used to energize an electrical load 14. The electrical load 14 can be part of a missile, such as a control actuation system (not shown). The batteries 12 can be thermal batteries, lead acid batteries, Li-Ion and the like. The batteries 12 are connected to a bus 16 with a positive side 18 and a negative side 20. The first battery 22 is activated and connected to the electrical load 14 before the second battery 24 is activated and connected to the electrical load 14. The bus 16 connects the batteries 12 to the load 14. The electrical load 14 can be supplied sequentially by a first battery current 42 from a first battery 22, and a second battery current from a second battery 24, up to an nth battery current from the nth battery (not shown).

The battery staging system 10 includes the first battery 22 in operative communication with the electrical load 14. The second battery 24 can be in operative communication with the electrical load 14 and in operative communication with the first battery 22.

A boost controller 26 can be in operative communication with the first battery 22 and the second battery 24. The boost controller 26 can include hardware, firmware, analog and/or software components that are configured to perform the functions disclosed herein, including the functions of the battery staging system 10. While not specifically shown, the boost controller 26 may include other computing devices (e.g., servers, mobile computing devices, etc.) which may be in communication with each other and/or the boost controller 26 via a communication network 28 to perform one or more of the disclosed functions. The boost controller 26 may include at least one processor 30 (e.g., a controller, microprocessor, microcontroller, digital signal processor, etc.), memory 32, and an input/output (I/O) subsystem 34. The boost controller 26 may be embodied as any type of computing device e.g., a network of computers, a combination of computers and other electronic devices, or other electronic devices. Although not specifically shown, the I/O subsystem 34 typically includes, for example, an I/O controller, a memory controller, and one or more I/O ports. The processor 30 and the I/O subsystem 34 are communicatively coupled to the memory 32. The memory 32 may be embodied as any type of computer memory device (e.g., volatile memory such as various forms of random access memory).

An inductor 36 is in operative communication with the boost controller 26, the first battery 22, a ground 38 and the second battery 24.

The first battery 22 is the initial battery to be activated. At a predetermined state, the second battery 24 can be activated in sequence. For a very brief period of time, both the first battery 22 and the second battery 24 are active and online with the load 14. The second battery 24 upon activation, goes online and picks up the load duty. The first battery 22 becomes offline. The battery staging system 10 is configured to prevent the offline first battery 22 from overheating and out-gassing during its offline stage, since the first battery 22 is still activated and producing current and generating thermal energy. Periodically, the first battery current 42 is drawn off the first battery 22 and utilized either in the second battery 24 or bus 16 to the load 14 or both.

The boost controller 26 is configured to connect the inductor 36 between the first battery 22 and the ground 38 for a predetermined time to obtain a predetermined inductor current 40. The boost controller 26 is configured to pull a first battery current 42 from the first battery 22 and drive the first battery current 42 into the second battery 24 responsive to the predetermined inductor current 40. The boost controller 26 is configured to connect the inductor 36 to the second battery 24 responsive to the inductor 36 obtaining the predetermined inductor current 40. The inductor 36 is reconnected between the first battery 22 and the ground 38 before the inductor current 40 reaches zero or goes below zero. The boost controller 26 can be configured to pull the first battery current 42 from the first battery 22 until a first battery voltage 44 reaches a target voltage of 10 percent of a full voltage value. When the first battery 22 obtains a target voltage of 10 percent of a full voltage value, the first battery 22 is considered to be in a safe condition. It is contemplated that in an exemplary embodiment the 10 percent value can be adjusted to other values that are considered to be a safe condition for the battery 22.

The battery staging system 10 includes a voltage measurement circuit 46 operatively connected between the boost controller 26 and the batteries 12. The voltage measurement circuit 46 can include a first resistor 48 in series with a second resistor 50. The voltage measurement circuit 46 indicates the battery voltage 44.

A current measurement circuit 52 can be operatively connected between the boost controller 46 and the inductor 36. The current measurement circuit 52 can include a shunt circuit, a Hall circuit, a current transformer and the like. The current measurement circuit 52 indicates the current between the inductor 36 and the first battery 22.

The battery staging system 10 includes a first power switch 54 in operative communication with the boost controller 26 on the low side 55. The first power switch 54 can be in between the first battery 22 and the second battery 24 to enable a path between the first battery 22 and the second battery 24. The first power switch 54 can be configured with a transistor 56, such as for example a power transistor, a Field Effect Transistor (FET), a Metal Oxide Semiconductor Field Effect Transistor (MOSFET), insulated-gate bipolar transistor (IGBT) and the like. The power switch 54 can be configured with a diode 58, such as a body diode or an external diode. The power switch 54 can be coupled on the low side of the load 14. The power switch 54 can have the transistor connected to a ground (not shown). The first power switch 54 can be in operative communication with the inductor 36. The boost controller 26 can operate the power switch 54 to alter the pathways for the current 40, 44 to flow.

A second power switch 60 can be in operative communication with the boost controller 26 on the high side. The second power switch 60 can be in between the first battery 22 and the second battery 24 to enable a path between the first battery 22 and the second battery 24. The second power switch 60 can include both a transistor 64 and a diode 66. In an exemplary embodiment, the second power switch 60 can be one of the transistor 64 or the diode 66. The second power switch 60 can be in operative communication with the inductor 36. The boost controller 26 can operate the power switch 60 to alter the pathways for the current 40, 44 to flow.

The power switches 54, 60 can utilize silicon carbide technology to improve the packaging and the power density. The power switches 54, 60 can be configured to be scaled. The power switches 54, 60 can enable a path for reverse current into one of the batteries 12 during regeneration from the control actuation system (not shown).

The boost controller 26 can include an inner loop 68, the inner loop 68 can be configured to control the first battery current 42. The inner loop 68 is configured to measure a loop error and apply one of a full voltage or no voltage for a predetermined period of time.

The boost controller 26 can include an outer loop 70. The outer loop 70 can be configured to control the first battery voltage 44.

The boost controller 26 is configured to transfer a charge from the first battery 22 to the second battery 24 or the load 14 or a combination of the second battery 24 and load 14 when the first battery 22 is offline and the second battery 24 is online. The boost controller 26 is configured to measure a battery impedance 72. The boost controller 26 is configured to determine an online battery resistance responsive to each of a measurement of the online battery voltage when the inductor 36 is connected to the online battery and measurement of the online battery voltage when the inductor 36 is disconnected from the online battery.

The boost controller 26 is a two-level controller, which uses the offline battery voltage and the inductor current 40 as measurement inputs. When the offline battery voltage is above its desired level, the discharge current from the offline battery is regulated to a target level. This is accomplished with a feedback controller which compares the target level to the actual inductor current 40. If the inductor current 40 is above the target level, the inductor 36 is connected between the offline and online batteries 12, which transfers the energy stored in the inductor into the online battery voltage rail. If a transistor is used as a switch to connect the inductor 36 to the online battery, it is turned off before the inductor current 40 begins to flow in the reverse direction. When the current is below the target, the inductor 36 is connected between the offline battery and ground 38, raising the current. When the offline battery voltage falls below the desired level, the desired current is set to zero and transistors in the boost controller 26 remain in the off state.

A power switch 74 can be electrically connected to the bus 16 on the positive side 18. A regen control input 76 is in operative communication with the power switch 74.

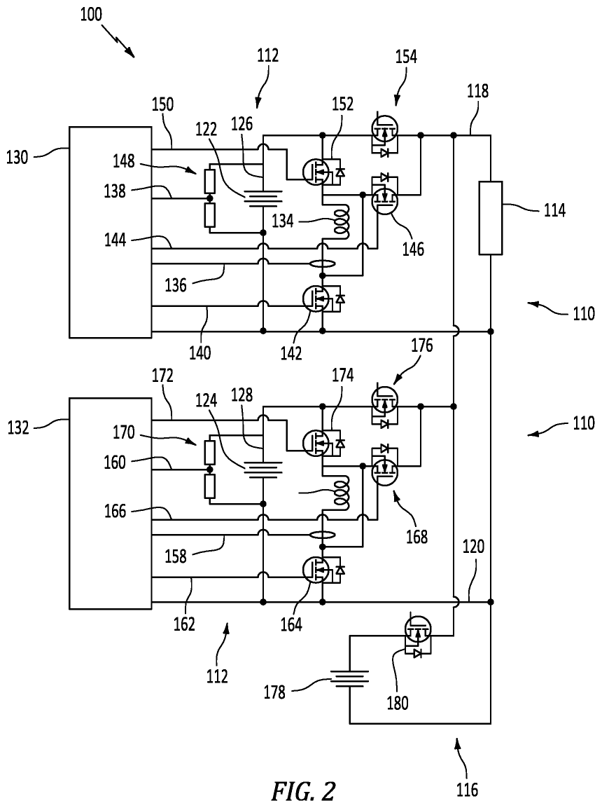

Referring also to FIG. 2, an exemplary battery staging system 100 is shown. In the exemplary battery staging system 100 a grouping of batteries 110 similar to the embodiment shown in FIG. 1, can be batteries 112 used to energize an electrical load 114. The batteries 112 are connected to a bus 116 with a positive side 118 and a negative side 120. A first battery 122 is activated and connected to the electrical load 114 before the second battery 124 is activated and connected to the electrical load 114. The bus 116 connects the batteries 112 to the load 114. The electrical load 114 can be supplied sequentially by a first battery current 126 from the first battery 122, and a second battery current 128 from the second battery 124.

The battery staging system 100 includes the first battery 122 in operative communication with the electrical load 114. The second battery 124 can be in operative communication with the electrical load 114 and in operative communication with the first battery 122.

In the exemplary battery staging system 100 a fist boost controller 130 is in operative communication with the first battery 122. A second boost controller 132 is in operative communication with the second battery 124. Similarly to the embodiment shown in FIG. 1, the first boost controller 130 and the second boost controller 132 have the same attributes as described above for the boost controller 26.

A first inductor 134 is in operative communication with the first boost controller 130 and the first battery 122. The first inductor 134 is similar in function to the inductor 36. A first current measurement circuit 136 is in operative communication with the first boost controller 130, with similar functions as the current measurement circuit 52. A first voltage measurement circuit 138 is in operative communication with the first boost controller 130, with similar functions as the voltage measurement circuit 46. A first pulse width modulation low-side circuit 140 is connected between the first boost controller 130 and a first low-side power switch 142. A first pulse width modulation high-side circuit 144 is connected between the first boost controller 130 and a first high-side power switch 146. The power switches 142, 146 are similar in function and design to the first power switch 54. The boost controller 130 can operate the power switches 142, 146 to alter the pathways for the current 126 to flow.

First resistor set 148 is in operative communication with the voltage measurement circuit 138 and includes similar function and design as the first resistor 48 and second resistor 50.

The battery staging system 100 includes a first boost circuit 150 in operative communication with the first boost controller 130 and a first boost power switch 152. When turned on, the first boost power switch 152 enables the boost power circuit. The (boost enable signal) first boost circuit 150 brings the boost converter online by enabling the (boost transistor) first boost power switch 152. This transistor 152 connects the circuit to battery power, providing the energy source to charge the boost inductor 134.

The battery staging system 100 includes a first regeneration power switch 154 in operative communication with the bus 116 and the first battery 122. The regeneration power switch 154 can enable a path for reverse current into one of the batteries 12 during regeneration from the control actuation system (not shown). The regeneration power switch 154 includes the function of when turned on, the regeneration power switch 154 enables current to flow with low loss from the battery 12 to the load 14. In addition, it enables regenerative current to flow back into the battery 12.

A second inductor 156 is in operative communication with the second boost controller 132 and the second battery 124. The second inductor 156 is similar in function to the inductor 36. A second current measurement circuit 158 is in operative communication with the second boost controller 132, with similar functions as the current measurement circuit 136. A second voltage measurement circuit 160 is in operative communication with the second boost controller 132, with similar functions as the voltage measurement circuit 138. A second pulse width modulation low-side circuit 162 is connected between the second boost controller 132 and a second low-side power switch 164. A second pulse width modulation high-side circuit 166 is connected between the second boost controller 132 and a second high-side power switch 168. The power switches 164, 168 are similar in function and design to the first power switch 54. Second resistor set 170 is in operative communication with the voltage measurement circuit 160 and includes similar function and design as the first resistor 48 and second resistor 50.

The battery staging system 100 includes a second boost circuit 172 in operative communication with the second boost controller 132 and a second boost power switch 174. When turned on, the power switch 174 enables the boost power circuit.

The battery staging system 100 includes a second regeneration power switch 176 in operative communication with the bus 116 and the second battery 124. The regeneration power switch 176 can enable a path for reverse current into one of the batteries 12 during regeneration from the control actuation system (not shown). The regeneration power switch 176 includes the function of when turned on, the regeneration power switch 176 enables current to flow with low loss from the battery 12 to the load 14. In addition, it enables regenerative current to flow back into the battery 12.

The battery staging system 100 includes an nth battery 178 in operative communication with the electrical load 14 and in operative communication with the first battery 22 and second battery 124. The nth battery is considered to be the last battery 12 in the system 110 that can be activated. The nth battery 178 will run until full discharge/depletion, since it is the last battery to be used. The battery staging system 100 includes an nth regeneration power switch 180 in operative communication with the bus 116 and the nth battery 178.

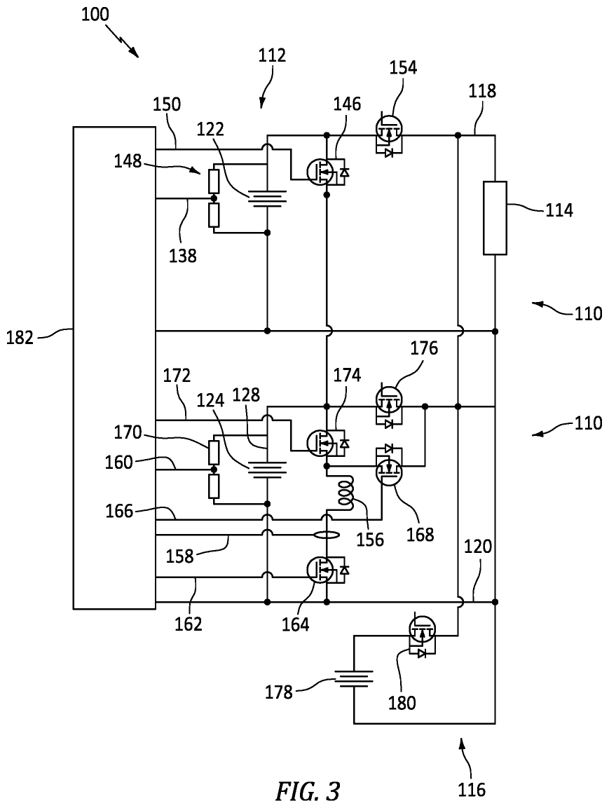

Referring also to FIG. 3, an exemplary battery staging system 100 is shown. The exemplary battery staging system 110 shown in FIG. 3 includes similar components as shown in FIG. 2. There is included a shared boost controller 182. The shared boost controller 182 performs similar functions to the first boost controller 130 and second boost controller 132.

FIG. 2 has switches 142 and 164 which prevent current from flowing through the high-side boost controller switches 146 and 168. In an exemplary embodiment of FIG. 2, the boost controller 132 is not being used unless an additional stage existed. In the case when a third stage is included, that third stage would not need to have a boost controller. If a third stage was present, both boost controllers 130 and 132 could drive power onto the bus if both batteries still retained charge. However, normally, the first battery's discharge would be completed before the second battery's discharge would need to be started. In another exemplary embodiment, if only one boost converter is active at a time, another embodiment of the invention would be a controller that is shared across multiple batteries. This would save space since the inductor and control electronics would not need to be replicated.

A technical advantage of the disclosed battery staging system includes enabling thermal batteries to support mission durations greater than 10 minutes.

Another technical advantage of the disclosed battery staging system includes better battery utilization, significantly reduces heat generation since inductors have low series resistance.

Another technical advantage of the disclosed battery staging system includes synchronous boost controller topology reduces power dissipation by passing inductor current through MOSFETs as opposed to asynchronous using diodes.

Another technical advantage of the disclosed battery staging system includes an inductor that is sized smaller than the alternative sized dissipation resistor.

Another technical advantage of the disclosed battery staging system includes a high current ripple being allowed as long as an average dissipation current is achieved; permitting lower switching frequencies, less precise duty cycle generation that would be normally required for such a high ratio boost converter.

Another technical advantage of the disclosed battery staging system includes an outer loop to control the offline battery voltage and an inner loop to ensure a minimum dissipation current while avoiding saturation of the magnetics.

Another technical advantage of the disclosed battery staging system includes both loops can be implemented with analog comparator and a flip-flop.

Another technical advantage of the disclosed battery staging system includes use of a sample/hold device to achieve simple dissipation current regulation.

Another technical advantage of the disclosed battery staging system includes the ability to measure battery impedance by capturing the voltage difference when the inductor current is released onto the active bus.

There has been provided a battery staging system. While the battery staging system has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A battery staging system comprising:
a first battery in operative communication with an electrical load;
a second battery in operative communication with the electrical load and in operative communication with the first battery;
a boost controller in operative communication with the first battery and the second battery;
an inductor in operative communication with the boost controller, the first battery, a ground and the second battery; whereby the inductor is connected between the first battery and the ground for a predetermined time to obtain a predetermined inductor current;
the boost controller is configured to pull a first battery current from the first battery and drive the first battery current into the second battery responsive to the predetermined inductor current;
the inductor being connected to the second battery responsive to the inductor obtaining the predetermined inductor current; whereby the inductor is reconnected between the first battery and the ground before the inductor current reaches zero; and
the boost converter controller configured to pull the first battery current from the first battery until the first battery voltage reaches a target voltage.

2. The battery staging system according to claim 1, wherein the first battery is a thermal battery and the second battery is a thermal battery.

3. The battery staging system according to claim 1, wherein the first battery is activated and connected to the electrical load before the second battery is activated and connected to the electrical load.

4. The battery staging system according to claim 1, wherein the boost controller includes an inner loop, the inner loop being configured to control the first battery current.

5. The battery staging system according to claim 4, wherein the inner loop is configured to measure a loop error and apply one of a full voltage or no voltage for a predetermined period of time.

6. The battery staging system according to claim 1, wherein the boost controller includes an outer loop; the outer loop being configured to control the first battery voltage.

7. The battery staging system according to claim 1, wherein the boost controller is configured to transfer a charge from the first battery to the second battery, wherein the first battery is offline and the second battery is online.

8. The battery staging system according to claim 1, wherein the boost controller is configured to measure battery impedance.

9. The battery staging system according to claim 1, wherein the boost controller is configured to determine an online battery resistance responsive to:
a measurement of the online battery voltage when the inductor is connected to the online battery; and
a measurement of the online battery voltage when the inductor is disconnected from the online battery.

10. A process for transferring charge from an offline battery to an online battery utilizing a boost controller comprising:
operatively connecting a first battery with an electrical load;
subsequently operatively connecting a second battery with the electrical load and operatively connecting the second battery in communication with the first battery;
operatively connecting a boost controller in operative communication with the first battery and the second battery;
operatively connecting an inductor in communication with the boost controller, the first battery, a ground and the second battery; whereby the inductor is connected between the first battery and the ground for a predetermined time to obtain a predetermined inductor current;
configuring the boost controller to pull a first battery current from the first battery and drive the first battery current into the second battery responsive to the predetermined inductor current;
connecting the inductor to the second battery responsive to the inductor obtaining the predetermined inductor current; whereby the inductor is reconnected between the first battery and the ground before the inductor current reaches zero; and
configuring the boost controller to pull the first battery current from the first battery until the first battery voltage reaches a target voltage.

11. The process of claim 10, wherein the first battery is a thermal battery and the second battery is a thermal battery.

12. The process of claim 10, further comprising:
activating and connecting the first battery to the electrical load before activating and connecting the second battery to the electrical load.

13. The process of claim 10, further comprising:
wherein the boost controller includes an inner loop; and
controlling the first battery current with the inner loop.

14. The process of claim 13, further comprising:
configuring the inner loop to measure a loop error and apply one of a full voltage or no voltage for a predetermined period of time.

15. The process of claim 10, further comprising:
wherein the boost controller includes an outer loop; and
controlling the first battery voltage with the outer loop.

16. The process of claim 10, further comprising:
configuring the boost controller to transfer a charge from the first battery to the second battery responsive to the first battery being offline and the second battery being online.

17. The process of claim 10, further comprising:
configuring the boost controller to measure battery impedance.

18. The process of claim 10, further comprising:
configuring the boost controller to determine an online battery resistance responsive to:
a measurement of the online battery voltage when the inductor is connected to the online battery; and
a measurement of the online battery voltage when the inductor is disconnected from the online battery.

19. The process of claim 10 further comprising:
controlling a first power switch with the boost controller; and
controlling a second power switch with the boost controller.

20. A battery staging system comprising:
a first battery in operative communication with an electrical load;
a second battery in operative communication with the electrical load and in operative communication with the first battery;
a first boost controller in operative communication with the first battery and in operative communication with the second battery;
a first inductor in operative communication with the first boost controller, the first battery, a ground and the second battery; whereby the first inductor is connected between the first battery and the ground for a predetermined time to obtain a first predetermined inductor current;
the first boost controller is configured to pull a first battery current from the first battery and drive the first battery current into the second battery responsive to the first predetermined inductor current;
the first inductor being connected to the second battery responsive to the first inductor obtaining the predetermined inductor current; whereby the first inductor is reconnected between the first battery and the ground before the first inductor current falls below zero; and the first boost controller configured to pull the first battery current from the first battery until the first battery voltage reaches a target voltage;
a second boost controller in operative communication with the second battery and in operative communication with an nth battery;
a second inductor in operative communication with the second boost controller, the second battery, a ground and the nth battery; whereby the second inductor is connected between the second battery and the ground for a predetermined time to obtain a second predetermined inductor current;
the second boost controller is configured to pull a second battery current from the second battery and drive the second battery current into an nth battery responsive to the second predetermined inductor current;
the second inductor being connected to the nth battery responsive to the second inductor obtaining the second predetermined inductor current; whereby the second inductor is reconnected between the second battery and the ground before the second inductor current falls below zero; and
the second boost controller configured to pull the second battery current from the second battery until the second battery voltage reaches a target voltage.
